(19) United States
(12) Patent Application Publication
(10) Pub. No.: US 2008/0271110 A1
(43) Pub. Date: Oct. 30, 2008

(54) Systems and Methods for Monitoring Compliance With Standards or Policies

(75) Inventors: David Graves, Monte Sereno, CA (US); Adrian John Baldwin, Bristol (GB); Yolanta Beresnevichiene, Bristok (GB); Simon Kai-Ying Shiu, Bristok (GB)

Correspondence Address: Hewlett-Packard Company;Intellectual Property Administration, PO Box 272400, Ft. Collins, CO, 80527-2400, US

(73) Assignee: Hewlett-Packard Development Company, L.P., Ft. Collins, CO (US)

(21) Appl. No.: 11/739,917

(22) Filed: Apr. 25, 2007

(51) Int. Cl. G06F 17/00

(52) U.S. Cl. 726/1

(57) ABSTRACT

In one embodiment, a system or method pertain to accessing a model that comprises a computer-readable version of a standard or policy, identifying rules or requirements specified by the model that pertain to compliance with the standard or policy, and automatically generating questions relevant to the identified rules or requirements, the questions being intended to query intended respondents as to compliance with the identified rules or requirements.

### BACKGROUND

In the present climate of growing regulatory mandates and industry-based requirements, business organizations are being forced to more vigorously examine the effectiveness of their internal information technology (IT) controls and processes. Indeed, regulations such as the Sarbanes-Oxley Act, the Health Insurance Portability and Accountability Act (HIPAA), and the Graham-Leach-Biley Act require organizations to demonstrate that their internal IT controls and processes are appropriate. In view of such requirements, information system security managers and owners are under increased pressure to provide more timely assurance that their controls and processes are working effectively and that risk is being properly managed.

Traditionally, the compliance of information systems is evaluated by conducting an annual audit. During such an audit, the auditors may collect evidence as to information system operation in the form of data collected from devices of system. In addition, the auditors may collect information from users of the information system that can be used to gauge compliance with an applicable industry standard or other policy. In such cases, the audit or may manually create questionnaires that query the system users as to specific control areas, process the replies received by the users, integrate the replies with the evidence collected from the system devices, and analyze the results in the context of the standard or policy. Understandably, such a process is time consuming and expensive. Furthermore, additional time and expense are required when the results are to be analyzed in the context of one or more other standards that may also be relevant to the information system, its operation, and its usage.

### BRIEF DESCRIPTION OF THE DRAWINGS

The components in the drawings are not necessarily to scale, emphasis instead being placed upon clearly illustrating the principles of the present disclosure. In the drawings, like reference numerals designate corresponding parts throughout the several views.

FIG. 1 is schematic diagram of an embodiment of operational infrastructure of an information system for which information relevant to compliance with standards and/or policies can be collected.

FIG. 2 is a block diagram of an embodiment of a computer that comprises a compliance monitoring system configured to collect information relevant to standards/policies compliance.

FIG. 3 is block diagram of an embodiment of a continuous compliance monitoring and modeling module shown in FIG. 2.

FIG. 4 is block diagram of embodiment of an automated information collection system shown in FIG. 2.

FIG. 5 illustrates a first example cross-reference that relates industry standards.

FIG. 6 illustrates a second example cross-reference that relates industry standards.

FIGS. 7A and 7B illustrate a flow diagram of an embodiment of a method for monitoring compliance with standards and/or policies.

FIG. 8 is a flow diagram of an embodiment of a method for providing monitoring findings to a user.

### DETAILED DESCRIPTION

As described above, manual methods for collecting information relevant to compliance of a given information system with one or more industry standards and/or policies can be time consuming and expensive. As described in the following, however, such information can be collected more easily and with less expense by automating the information collection process. In some embodiments, such automation comprises automatically generating questionnaires based upon information contained in computer-readable models of the standards/policies, automatically processing the results and integrating them with evidence collected from devices of the system, and automatically generating audit compliance results that can be reviewed by an appropriate person, such as an system administrator or auditor. In some embodiments, the results can be automatically reconfigured from multiple points of view pertaining to different industry standards/policies to provide an indication of the level of compliance from the perspective of each individual standard/policy.

In the following, various system and method embodiments are disclosed. Although specific embodiments are described, those embodiments are mere example implementations. Therefore, other embodiments are possible. All such embodiments are intended to fall within the scope of this disclosure.

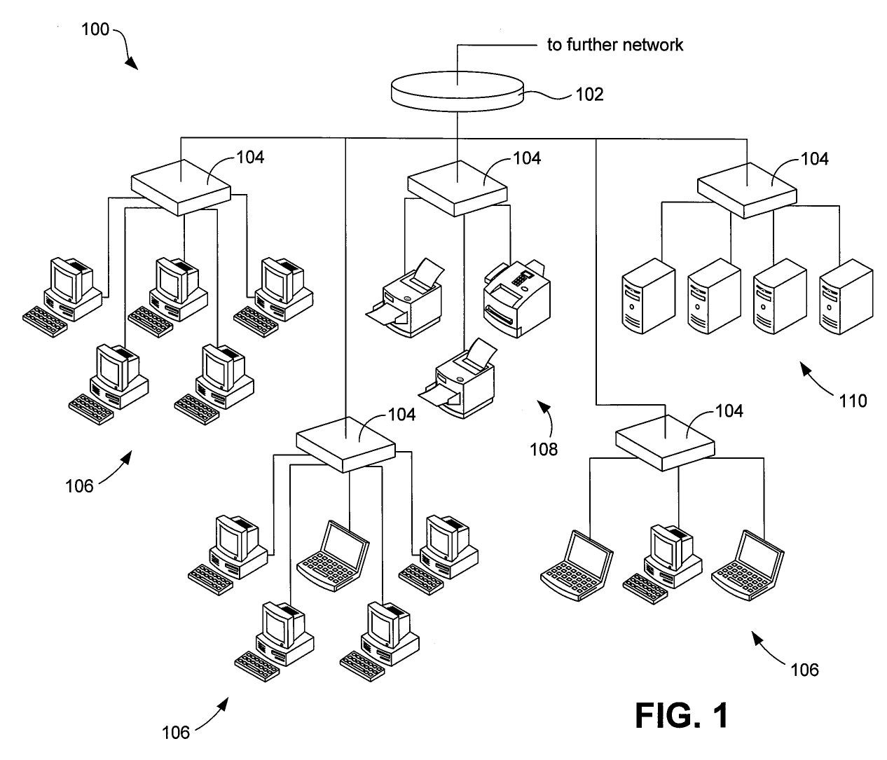

Referring now to the drawings, in which like numerals indicate corresponding parts throughout the several views, FIG. 1 illustrates an example operational infrastructure 100 of an information system that is to comply with certain industry standards, which may be imposed by an external entity (e.g., government), and/or policies, which may be imposed by a particular organization (e.g., enterprise). As is apparent from FIG. 1, the infrastructure 100 may define a network or part of a network, such as a local area network (LAN), that can be connected to and communicate with another network, such as another LAN or a wide area network (WAN). In the example of FIG. 1, the infrastructure 100 includes a router 102 that routes data to and from multiple switches 104, to which multiple network-enabled devices are connected. In FIG. 1, the devices connected to the switches 104 include client computers 106, peripheral devices 108, and server computers 110.

The client computers 106 can comprise desktop computers as well as laptop computers. The peripheral devices 108 can comprise printing devices to which print jobs generated by the client computers 106 can be sent for processing. Such printing devices may comprise dedicated printers, or may comprise multifunction devices that are capable of printing as well as other functionalities, such as copying, emailing, faxing, and the like. The server computers 110 may be used to administer one or more processes for the infrastructure 100. For example, one server computer may act in the capacity as a central storage area, another server computer may act in the capacity of a print server, another server computer may act as a proxy server, and so forth.

Generally speaking, each of the devices of the infrastructure 100, including the router 102 and the switches 104, participate in operation of the information system and therefore may need to be checked for compliance with one or more standards and/or policies. It is noted that although relatively few devices are shown in FIG. 1 by way of example, the information system under evaluation and its infrastructure may comprise many, such as hundreds or even thousands, of such devices, thereby making manual auditing relatively challenging. Furthermore, although the information system is shown as comprising only client computers, printing devices, and server computers, the system may comprise any number of other types of devices that also define the information system and characterize its operation and use.

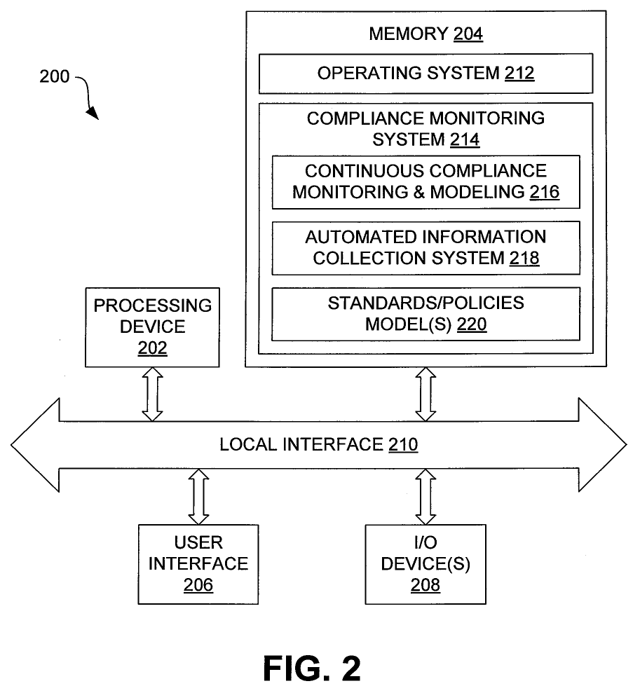

FIG. 2 is a block diagram illustrating an example architecture for a computer 200 that can be used to evaluate the infrastructure 100 of FIG. 1 and automatically collect information as to standards compliance. In some embodiments, the computer can be one of the client computers 106 or one of the server computers 110. In other embodiments, the computer 200 can be external to the infrastructure 100. Regardless, the computer 200 comprises a processing device 202, memory 204, a user interface 206, and at least one I/O device 208, each of which is connected to a local interface 210.

The processing device 202 can include a central processing unit (CPU) or a semiconductor-based microprocessor. The memory 204 includes any one of a combination of volatile memory elements (e.g., RAM) and nonvolatile memory elements (e.g., hard disk, ROM, tape, etc.).

The user interface 206 comprises the components with which a user interacts with the computer 200. The user interface 206 may comprise, for example, a keyboard, mouse, and a display, such as a cathode ray tube (CRT) or liquid crystal display (LCD) monitor. The one or more I/O devices 208 are adapted to facilitate communications with other devices and may include one or more communication components, such as a wireless (e.g., radio frequency (RF)) transceiver, a network card, etc.

In the embodiment of FIG. 2, the memory 204 comprises various programs including an operating system 212 and a compliance monitoring system 214, which includes a continuous compliance monitoring and modeling system 216 (“CCMM”), an automated information collection system 218, and standards/policies models 220. The operating system 212 controls the execution of other programs and provides scheduling, input-output control, file and data management, memory management, and communication control and related services. As described in greater detail below, the CCMM 216 is an automated evaluation system that monitors the infrastructure of an information system under evaluation, automatically evaluates compliance of the information system and its operation relative to one or more standards and/or policies, and automatically identifies instances of non-compliance (i.e., problems) that must be remedied to achieve full compliance with the applicable standards and/or policies. As is also described in greater detail below, the automated information collection system 218 automatically generates questionnaires for information system users based upon information contained in computer-readable models of the standards/policies and automatically processes the results obtained relative to the questionnaires.

The standards/policies models 220 comprise models of various industry standards and/or organization policies that are used to determine the adequacy of an information system, its operation, and its usage. Example industry standards include Control Objectives for Information and related Technology (COBIT), Information Technology Infrastructure Library (ITIL), and various standards established by the International Organization for Standardization (ISO). The models 220 may be described as computer-readable versions of the standards/policies

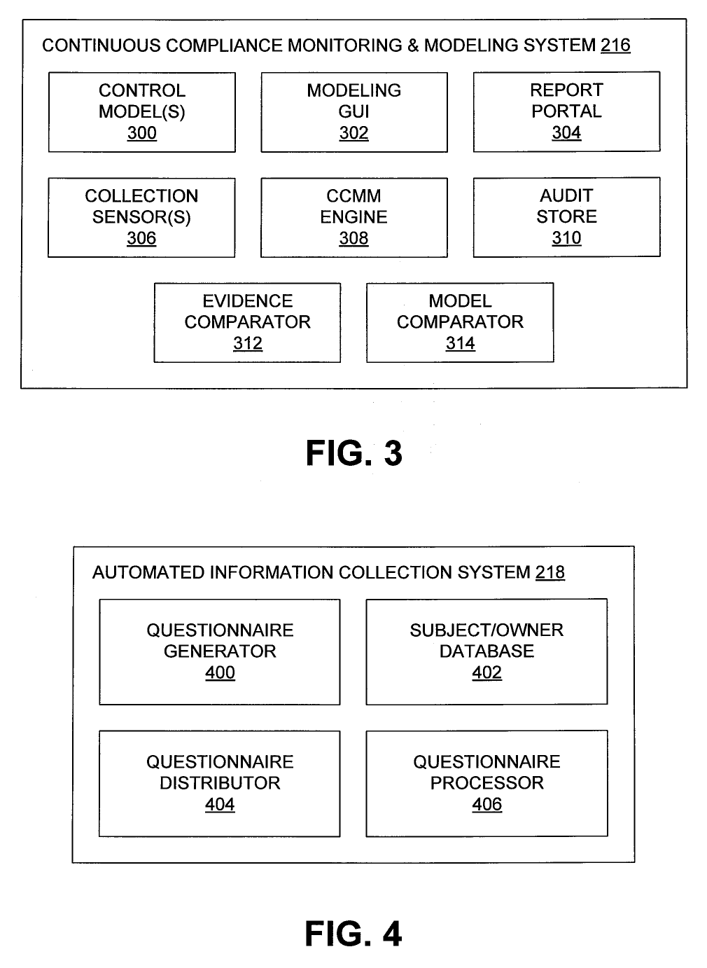

FIG. 3 illustrates an example configuration for the CCMM 216 shown in FIG. 2. As mentioned above, the CCMM 216 is configured to monitor the infrastructure of an information system under evaluation, automatically evaluate compliance of the information system and its operation relative to one or more established policies and/or standards, and automatically identify problems that must be remedied to achieve full compliance with the applicable policies and/or standards. Therefore, the CCMM 216 automates the tasks normally performed by one or more human auditors during an annual audit. As indicated in FIG. 3, the CCMM 216 includes one or more control models 300, a modeling GUI 302, a report portal 304, one or more collection sensors 306, a CCMM engine 308, and an audit store 310.

The control models 300 comprise computer-readable versions of the standards and/or policies applicable to the information system under evaluation. In some embodiments, the control models 300 are, include, or form part of the models 220 identified in FIG. 2. The standards/policies can pertain to one or more of information security, information technology, and service control. Given that compliance of the information system is determined relative to those standards/policies, the control models 300 drive the evaluation process performed by the CCMM 216. The control models 300 specify the data sources and the operations to be performed on the data that is collected. Because the control models 300 capture security and audit processes in a rigorous manner, the models form a foundation for incremental improvement of the information system from a compliance standpoint. A library of control models 300 can be provided, representing any number of standards/policies from which compliance can be independently or collectively judged.

The modeling GUI 302 provides an interface for a user, such as a system administrator or auditor, to create and modify the control models 300. In addition, the modeling GUI 302 can be used to make various selections that are used in the system evaluation process. In at least some embodiments, the modeling GUI 302 provides a simple graphical environment for defining each model 300 that can be used with a minimal understanding of computer programming.

The report portal 304 controls access to automatically generated reports that describe the findings obtained through the evaluation of the information system. In some embodiments, the report portal 304 takes the form of a web site that authorized persons can access to view the reports. The reports document the results of automated security and audit processes as specified by the control models 300. The reports can provide anywhere from a high-level indication of the system's compliance with few details to a low-level indication of compliance including a great amount of detail. A user can review controls documentation to understand the model that has been applied and then review the resulting report to understand the results obtained through analysis of evidence collected during the evaluation.

The collection sensors 306 comprise components and/or instrumentations that extract data from the operational infrastructure of the information system under evaluation. Therefore, the sensors 306 are used by the CCMM 216 to cull the various data from the infrastructure that will be used to determine how well the information system complies with the applicable standards/policies. There are multiple sources from which the sensors 306 can obtain evidence in an unobtrusive manner, such as security and audit information in a data warehouse, the application programming interface (API) of an enterprise application, and log files from infrastructure devices or applications.

The CCMM engine 308 comprises the “intelligence” of the CCMM 216 and controls overall operation of the CCMM. More specifically, the CCMM engine 308 reviews the control models 300 that are to be applied in the evaluation, drives the collection of evidence pertinent to the control models using the sensors 306, processes the collected evidence relative to the control models, and generates and formats the reports that are accessible to a user via the report portal 304. Notably, the CCMM engine 308 can rapidly adapt to new security and audit models and changes to the CCMM engine software are typically not required. To exploit a new type of security or audit control, all that are required are a new model 300 and appropriate sensors 306 to collect the data for the model. The formatting of the report is automatically changed by the CCMM engine 308 relative to the model 300 that has been applied.

The audit store 310 serves as a repository for intermediate results as specified by the control models 300 and, therefore, can be used to store information collected by the sensors 306. In addition, the audit store 310 can be used to store the final results, including any reports generated by the CCMM engine 308. In some embodiments, the audit store 310 is deployed as a MySQL database on a Windows platform or as an Oracle database.

The evidence comparator 312 is configured to generate reports that compares responses to questionnaires provided to relevant persons (described below) with the evidence collected directly from the information system using the sensors 306 to show the coverage of the automated evaluation. Instances in which the questionnaire results significantly differ from the results obtained using the sensor 306 may reveal potential issues that require remediation.

The model comparator 314 is configured to support analysis of evidence collected from the information system and questionnaire respondents relative to various different industry standards and/or organization policies using a mapping composed of cross-references that correlate provisions from given standards/policies with those of other standards/policies. With the model comparator 314, the evidence can alternately be used to indicate compliance with any one of the standards/policies.

FIG. 4 illustrates an example configuration of the automated information collection system 218 shown in FIG. 2. In the embodiment of FIG. 4, the collection system 218 comprises a questionnaire generator 400, a subject/owner database 402, a questionnaire processor 404, and a questionnaire database 406. The questionnaire generator 400 is configured to create questionnaires intended for users, such as IT professionals, of the information system under evaluation who act in the capacity of questionnaire respondents. Generally speaking, the questionnaires query those respondents as to their opinions as to their organization's satisfaction of control objectives and/or as to their assessment of system controls relative to the industry standards and/or organization policies.

In some embodiments, the questionnaire generator 400 automatically generates the questions for the questionnaires by accessing the standards/policies models 220 to identify various rules or requirements established by the standards and/or policies that the models represent and by presenting those rules/requirements to the respondents for review and querying them as to their opinions as to the organization's and/or the information system's compliance with those rules/requirements.

The questionnaires can query the recipients as to any one of a variety of issues concerning the information system, its operation, or its use. In some embodiments, separate questionnaires are generated for separate topics. For example, separate questionnaires can be generated that relate to particular system “subjects,” such as client computers, server computers, switches, routers, applications, business processes, and so forth. Furthermore, the questionnaires can be generated so as to specifically apply to particular “owners” (e.g., system administrators or operators) of those subjects. Specifically, the questionnaires can be filtered so that the owners are queried only as to subjects about which they may have information using the subject/owner database 402, which correlates the various subjects with their owners. For example, if a given subject is a data center of the information system, a questionnaire can be specifically generated for and directed to the person(s) responsible for the data center.

In some embodiments, the questionnaires are generated as computer-readable forms that can be updated with the replies of intended respondents who access the forms via a suitable electronic interface, such as a web site. In other embodiments, the questionnaires are printed as paper forms that can be physically distributed to the intended respondents for completion, and the handwritten responses can be entered into the automated information collection system 218.

Once the questionnaires are generated, they can be distributed to the various intended respondents using the questionnaire distributor 404. In some embodiments, the questionnaire distributor 404 maintains or accesses address information (e.g., email addresses) regarding the various intended respondents and further comprises a mechanism (email application) with which the questionnaires can be transmitted to those addresses. In other embodiments, the questionnaire distributor 404 is configured to send the questionnaires to suitable printing devices for processing into hard copy questionnaires. The questionnaire distributor 404 can further initiate a workflow process that ensures that the questionnaires are completed and the replies to their various questions are received.

The questionnaire processor 406 receives the replies to the questions posed to the respondents and processes them to place the information contained in the replies in a format suitable for recorded evidence. In at least some embodiments, the questionnaire processor 406 provides the processed replies to the CCMM engine 308 to enable the engine to be processed along with the evidence collected from the system devices by the CCMM 216. In such cases, the questionnaire results can be included in the reports generated by the CCMM 216. Individual question results can be explicitly identified with great detail. In some embodiments, responses from multiple persons can be combined using predetermined rules. For example, under one such rule, the response indicating the worst system performance could be presented or the average response could be presented. In some embodiments, an indication of the severity of an issue can also be provided. For example, were a given questionnaire response identifies a serious problem with the information system or the manner in which it is used, a red flag or other visual indicator can be associated with the response to call the reader's attention to the response.

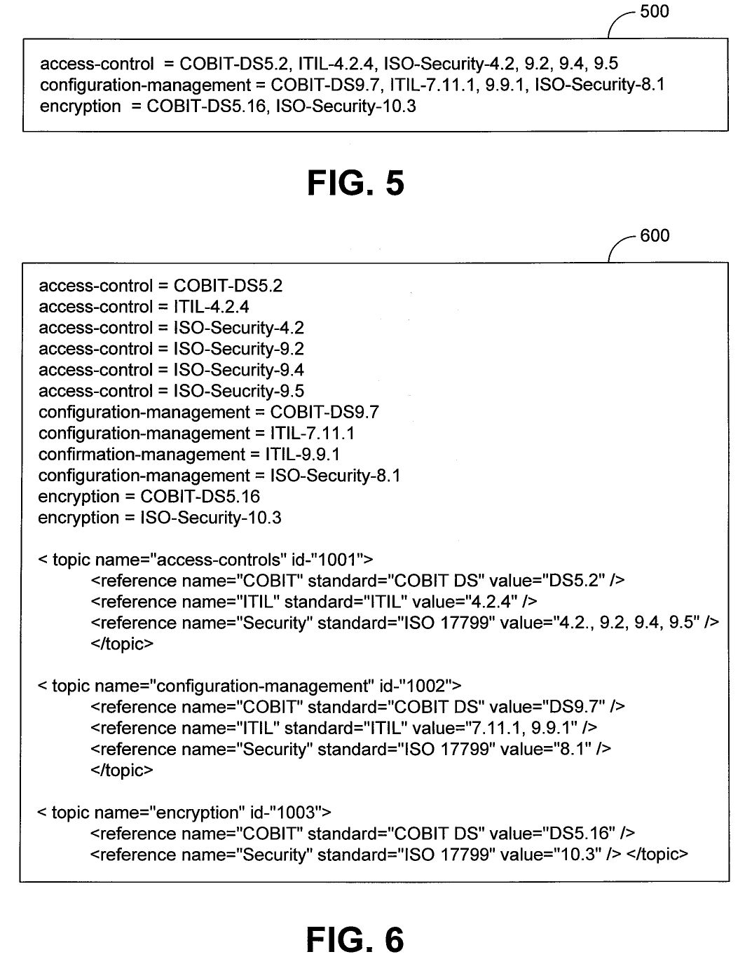

FIGS. 5 and 6 illustrates example instances of a cross-reference that may be comprised by the standards/policies models described above. In the example of FIG. 5, the cross-reference comprises a plain text file. In the example of FIG. 6, the cross-reference comprises an XML file. In both FIGS. 5 and 6, the cross-references identify various industry standards (COBIT, ITIL, ISO) and associates provisions of the standards with each other so that information pertinent to or derived from one of the standards can be related to the other standards, as applicable.

Various programs (i.e. logic) have been described herein. The programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

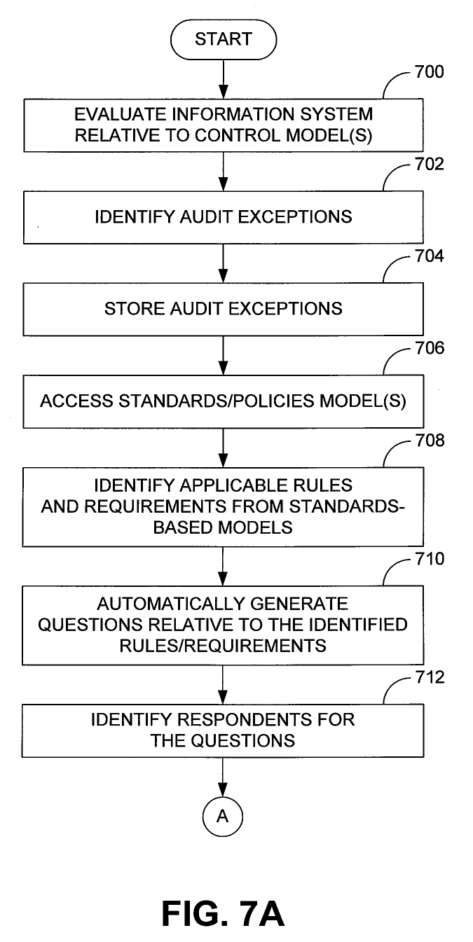

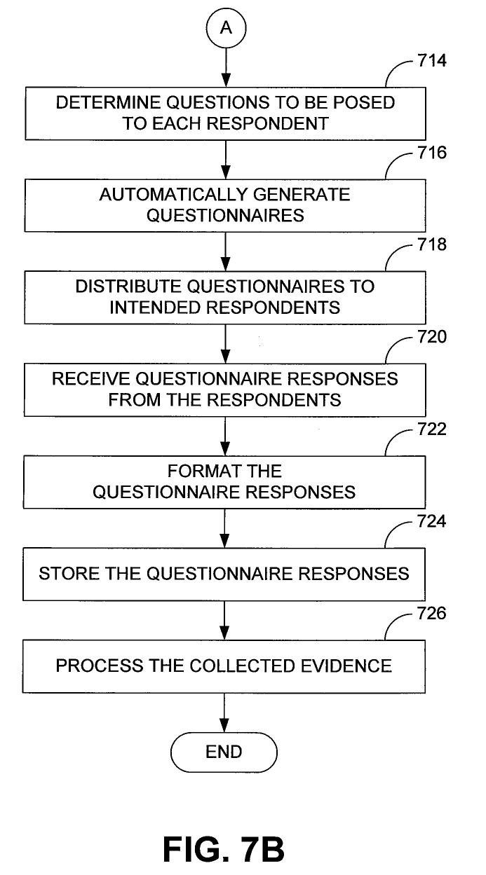

FIGS. 7A and 7B illustrate an example method for monitoring an information system for compliance with one or more standards and/or policies. Beginning with block 700 of FIG. 7A, an information system, and more particularly the operational infrastructure of the system, is evaluated relative to one or more control models. By way of example, the evaluation is automatically conducted by the CCMM as described above. Through the evaluation, any audit exceptions are identified, as indicated in block 502. As described above, the audit exceptions can pertain to infrastructure devices as well as applications. The nature of the audit exceptions will depend upon the standards/policies upon which the control models are based and can therefore take a variety of forms. Example exceptions include a terminated employee's login account still being active, a login account being inactive for an extended period of time, the age of a device being greater than an established threshold, a version of an application being outdated, an internal procedure failing to recognize old devices/applications, absence of recommended security patches, failure to execute anti-virus software, a recommended device configuration not being implemented, and so forth. After being identified, the audit exceptions and any associated information can be stored, as indicated in block 704. By way of example, the audit exception information is stored in the audit store of the CCMM.

As indicated above, questionnaires can also be used to collect evidence as to information system compliance. Such questionnaires can be used query intended respondents, such as IT professionals, for their viewpoints regarding compliance of the information system, its operation, or its use relative to one or more standards/policies models and, therefore, relative to one or more industry standards and/or organization policies. As also indicated above, the questionnaire generator can be used to develop the questionnaires. To that end, the questionnaire generator accesses one or more of the standards/policies models, as indicated in block 706. Referring to block 708, the questionnaire generator can then identify one or more applicable rules and/or requirements contained in the models and therefore specified by one or more industry standards. The rules/requirements can relate to any one of a variety of issues concerning the information system, its operation, or its use. For example, the rules may specify that a terminated employee's login account must be deactivated after a given period of time, a login account may not be inactive for an extended period of time, a given device cannot be older than a given threshold, a given application must be a recent version, particular security patches must have been installed, certain anti-virus software must be running, and so forth. As can be appreciated from those examples, the rules/requirements may relate system devices, applications, and business processes.

Once the rules/requirements have been identified, the questionnaire generator automatically generates one or more questions, as indicated in block 710. In some embodiments, the questions can comprise a restatement of the rule/requirement and query the intended respondent as to his or her opinion as to the current level of compliance with that rule/requirement, which may be indicated by selecting an appropriate answer. For example, a given question may be as follows:
4. “Employee login accounts must be deactivated within 90 days of termination of the employee.” Our organization/system is fully compliant with that rule.

| | |
|---|---|
| 5 | Strongly agree |
| 4 | . |
| 3 | . |
| 2 | . |
| 1 | Strongly disagree |

Answer:

With such a format, the respondent can provide his or her opinion as to how well particular rules/requirements are being complied with.

In some embodiments, separate questionnaires can be generated not only for separate standards/policies models but also for different aspects of the information system. Given that different persons may be responsible for those different aspects of the system, different questionnaires may be sent to different intended respondents. Indeed, in some embodiments, it is possible to customize the questionnaires for each of the intended respondents. To do this, the questionnaire generator identifies the various intended respondents for the questions, as indicated in block 712. In some embodiments, the questionnaire generator identifies the appropriate intended respondents from the subject/owner database. In such a case, the responsible persons, or “owners,” of the system aspects that are the subject of the question can be identified. Through identification of the intended respondents, the questionnaire generator can determine which questions are to be posed to which intended respondents, as indicated in block 714 of FIG. 7B.

Once the questions have been generated and the persons to whom the questions are to be posed identified, the questionnaire generator can automatically generate the questionnaires, as indicated in block 716, and the questionnaires can be distributed to the intended respondents, as indicated in block 718. As described above, the questionnaires can be distributed with assistance from the questionnaire distributor. Again, the questionnaires can be electronically transmitted to the intended respondents or to a printing device for processing as a hard copy document.

Referring next to block 720, the questionnaire responses are received from the respondents. By way of example, the responses are received by the questionnaire processor. In some embodiments, the responses are received directly from the respondents, for example when the respondents directly register their responses using an online questionnaire. In other embodiments, the responses are handwritten by the respondents and then input to the questionnaire processor through a data entry process. As indicated above, the responses may simply comprise selections, such as selected numbers or answers, that provide an indication as to compliance as to various topics.

Once the responses are received, they are formatted so as to be suitable as recorded evidence, as indicated in block 722, and then stored, as indicated in block 724. By way of example, the responses are stored in the audit store of the CCMM. At this point, the CCMM engine can process the evidence collected from both the sensors and the respondents, as indicated in block 726. Such processing may comprise associating evidence collected by the sensors with evidence collected from the respondents. For example, if the sensors collected information about deactivation of employee login accounts and one of the questionnaire questions pertained to deactivation of employee login accounts the information from the sensors and the response can be tagged as being relevant to the same compliance topic. Furthermore, the processing may comprise associating the evidence collected from the sensors and the respondents with the various provisions of the applicable standards. Therefore, each piece of evidence can be identified as being relevant to one or more such provisions.

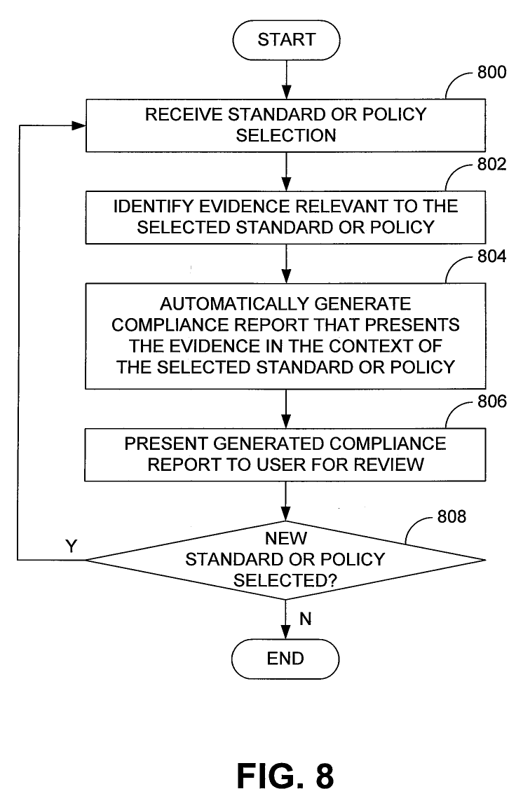

At this point, the data needed to report on the compliance of the information system with one or more standards and/or policies has been collected. FIG. 8 describes a method for providing the findings to a user, such as a system administrator or auditor. Beginning with block 800, a standard or policy selection is received by the CCMM. By way of example, the selection can have been input by the user with the modeling GUI described above. Once the selection has been received, the evidence relevant to the selected standard or policy is identified, as indicated in block 802. The response evidence can be identified as being relevant when the evidence is responsive to questions that were generated from rules/requirements derived from the standards/policies model that models the selected standard or policy. In addition, responses to questions generated from different standards/policies models may be considered relevant in cases in which a cross-reference identifies the response as being relevant to one or more provisions of another standard or policy.

Once the relevant evidence has been identified, the CCMM automatically generates a compliance report that presents the evidence in the context of the selected standard or policy, as indicated in block 804. In some embodiments, the evidence can be presented in the same order as the various provisions of the selected standard or policy. In further embodiments, the various rules/requirements of the selected standard or policy can also be presented. Regardless, the report presents the evidence in a manner in which the user will be able to determine compliance of the information system relative to the selected standard or policy.

With reference to decision block 808, if a new standard or policy is selected, flow returns to block 800 and a new compliance report is generated, this time from the perspective of the newly selected standard or policy. Notably, the new compliance report may have a different format due to differences between the two standards/policies. However, the CCMM can generate the new compliance report with relative ease due to the cross-references that associate the provisions of the various standards and policies.

From the foregoing, it can be appreciated that, using the disclosed systems and methods, the opinions of information system users, such as IT professionals, as to compliance of the system with industry standards and/or organization policies can be more easily and more cost effectively collected and presented for review by an appropriate person, such as a system administrator or auditor. Furthermore, due to the provision of cross-references between the provisions of such standards/policies, those opinions can be independently reviewed from the perspective of multiple different standards and policies. Although the terms “standard” and “policy” are used to separately identify industry standards and organization policies, it is noted that both sources of rules and/or requirements can be identified by the term “standard.” Therefore, the term “standard” is used as an inclusive term that refers to both industry standards and organization policies.

Claimed are the following:

1. A method for monitoring compliance of an information system with a standard or policy, the method comprising:
accessing a model that comprises a computer-readable version of the standard or policy;
identifying rules or requirements specified by the model that pertain to compliance with the standard or policy; and
automatically generating questions relevant to the identified rules or requirements, the questions being intended to query intended respondents as to compliance with the identified rules or requirements.

2. The method of claim 1, wherein automatically generating questions comprises generating questions that identify the rule or requirement and that query the intended respondents as to their opinions as to compliance with the identified rule or requirement.

3. The method of claim 1, further comprising determining which questions are to be presented to which respondents based upon aspects of the information system with which the respondents are individually familiar.

4. The method of claim 3, wherein automatically generating questions comprises generating questionnaires comprising multiple questions for the intended respondents, wherein at least two of the questionnaires comprise different questions.

5. The method of claim 1, further comprising facilitating distribution of the questions to the intended respondents.

6. The method of claim 5, wherein facilitating distribution comprises providing the questions to the intended respondents in electronic form.

7. The method of claim 5, wherein facilitating distribution comprises facilitating printing of the questions in hard copy documents.

8. The method of claim 5, further comprising receiving responses to the questions provided by the respondents.

9. The method of claim 8, further comprising processing the responses.

10. The method of claim 9, wherein processing the responses comprises associating the responses with evidence collected from devices of the information system.

11. The method of claim 10, further comprising automatically generating a compliance report that presents the responses and the evidence collected from the devices from the perspective of the standard or policy.

12. The method of claim 11, further comprising automatically identifying rules or requirements of a second standard or policy to which the responses and the evidence collected from the devices are individually relevant and automatically generating a new compliance report that presents the responses and the evidence collected from the devices from the perspective of the second standard or policy.

13. A system for monitoring compliance of an information system with a standard or policy, the system comprising:
means for identifying rules or requirements specified by a model that pertain to compliance with the standard or policy; and
means for automatically generating questions relevant to the identified rules or requirements, the questions being intended to query intended respondents as to compliance with the identified rules or requirements.

14. The system of claim 13, further comprising means for determining which questions are to be presented to which respondents based upon aspects of the information system with which the respondents are individually familiar.

15. The system of claim 13, further comprising means for facilitating distribution of the questions to the intended respondents.

16. The system of claim 13, further comprising means for receiving responses to the questions provided by the respondents.

17. The system of claim 16, further comprising means for automatically generating a compliance report that presents the responses from the perspective of the standard or policy.

18. The system of claim 11, further comprising means for automatically identifying rules or requirements of a second standard or policy to which the responses are individually relevant and means for automatically generating a new compliance report that presents the responses from the perspective of the second standard or policy.

19. A computer-readable medium that stores a compliance monitoring system, the system comprising:
an automated information collection system configured to access a model that comprises a computer-readable version of a standard or policy, to identify rules or requirements specified by the model that pertain to compliance with the standard or policy, and to automatically generate questions relevant to the identified rules or requirements, the questions being intended to query intended respondents as to compliance of an information system with the identified rules or requirements; and
a continuous compliance monitoring and modeling system configured to automatically collect evidence from devices of the information system operation, to receive responses to the questions, and to automatically generate a compliance report that presents the collected evidence and the received responses from the perspective of the standard or policy.

20. The computer-readable medium of claim 19, wherein the automated information collection system is further configured to determine which questions are to be presented to which respondents based upon aspects of the information system with which the respondents are individually familiar.

21. The computer-readable medium of claim 19, wherein the automated information collection system is further configured to facilitate distribution of the questions to the intended respondents.

22. The computer-readable medium of claim 19, wherein the automated information collection system is further configured to receive responses to the questions provided by the respondents and provide the responses to the continuous compliance monitoring and modeling system.

23. The computer-readable medium of claim 19, wherein the continuous compliance monitoring and modeling system is further configured to automatically identify rules or requirements of a second standard or policy to which the responses and the evidence collected from the devices are individually relevant and to automatically generate a new compliance report that presents the responses and the evidence collected from the devices from the perspective of the second standard or policy.
